(19) United States
(12) Patent Application Publication
(10) Pub. No.: US 2008/0093130 A1
(43) Pub. Date: Apr. 24, 2008

(54) TOUCH SENSOR UNIT AND METHOD OF CONTROLLING SENSITIVITY THEREOF

(75) Inventors: Dong-ki Lee, Seoul (KR); Joon-ho Won, Suwon-si (KR); Byung-gun Kim, Yongin-si (KR); Eung-chan Kim, Anyang-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/751,239

(22) Filed: May 21, 2007

(30) Foreign Application Priority Data
Oct. 19, 2006 (KR) 2006-102042

(51) Int. Cl. G06F 3/041

(52) U.S. Cl. 178/18.01; 178/18.03; 345/173

(57) ABSTRACT

A touch sensor unit and a method of controlling the sensitivity of the touch sensor include a supporting substrate, a touch sensor disposed on the supporting substrate, a cover having a three-dimensional form disposed on the touch sensor, and a control unit controlling the sensitivity of the touch sensor by applying weighted values to the sensitivity, wherein the sensitivity corresponds to three-dimensional location data of the cover.

### CROSS-REFERENCE TO RELATED APPLICATION

This application claims the benefit of Korean Application No. 2006-102042, filed Oct. 19, 2006, in the Korean Intellectual Property Office, the disclosure of which is incorporated herein by reference.

### BACKGROUND OF THE INVENTION

1. Field of the Invention

Aspects of the present invention relate to a touch sensor unit and a method of controlling the sensitivity of the touch sensor unit, and more particularly, to a touch sensor unit having a cover with a non-uniform thickness and a method of controlling the sensitivity of the touch sensor unit according to the structure of the cover.

2. Description of the Related Art

A conventional touch sensor unit 1, such as the type used in MP3 players, includes a touch sensor 13 disposed on a flat pad 10 and a flat cover 15 disposed on the touch sensor 13, as illustrated in FIG. 1A. The conventional touch sensor 13 generally has a uniform sensitivity over its entire upper surface, as represented by the uniform horizontal and vertical “sensitivity” lines illustrated in FIG. 1B. Therefore, when the cover 15 is flat with a uniform thickness, an error generation rate is low. In contrast, when the cover 15 has a non-uniform thickness, the extent to which the touch sensor 13 senses contact of the cover 15 varies according to the thickness of the cover 15, and as a result, many errors are generated when using a cover 15 having a non-uniform thickness. Therefore, in order to maintain a low error generation rate, a shape of the cover 15 is conventionally limited to a flat shape having a uniform thickness.

However, when the touch sensor unit 1 is employed in an input device, various types of designs for the cover 15 are desirable, including designs having a cover 15 with a non-uniform thickness.

### SUMMARY OF THE INVENTION

Aspects of the present invention provide a touch sensor unit having a cover with a non-uniform thickness and a method of controlling the sensitivity of the touch sensor unit.

According to an aspect of the present invention, a touch sensor unit includes a supporting substrate, a touch sensor disposed on the supporting substrate, a cover having a three-dimensional form disposed on the touch sensor; and a control unit to control a sensitivity of the touch sensor by applying weighted values to the sensitivity, wherein the sensitivity corresponds to three-dimensional location data of the cover.

According to an aspect, the weighted values are proportional to a thickness of the cover.

According to an aspect, the cover includes an active region in which a touch signal is recognized, and an inactive region in which a touch signal is blocked.

According to another aspect of the present invention, a method of controlling a sensitivity of a touch sensor unit having a supporting substrate, a touch sensor disposed on the supporting substrate, and a cover disposed on the touch sensor includes collecting three-dimensional location data of the cover, measuring a sensitivity of the touch sensor corresponding to the three-dimensional location data, and controlling the sensitivity by applying weighted values to the measured sensitivity.

According to another aspect, the three-dimensional location data is generated using a three-dimensional modeling function.

According to another aspect, the weighted values are obtained by applying an inverse transform to the three-dimensional modeling function.

According to another aspect, the method further includes setting a correction range of the touch sensor and controlling the sensitivity of the touch sensor to be corrected within the correction range.

According to another aspect, the method further includes obtaining a standard input pattern by performing a usability test.

According to another aspect, the method further includes dividing an input pattern based on a touch signal inputted by a user into a plurality of scale vectors, measuring a similarity value of each of the plurality of scale vectors by comparing the standard input pattern to each of the plurality of scale vectors from the input pattern, and selecting an input order of the scale vectors according to the similarity values from a highest similarity value to a lowest similarity value.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1A is a diagram of a conventional touch sensor unit having a layered structure with a cover of uniform thickness;

FIG. 1B illustrates the sensitivity of the touch sensor unit illustrated in FIG. 1A;

FIG. 2A is a diagram of a touch sensor unit having a layered structure according to an embodiment of the present invention;

FIG. 2B shows a plan view and a side view of the touch sensor unit illustrated in FIG. 2A;

FIG. 3 is a diagram of a touch sensor unit according to another embodiment of the present invention;

FIG. 4 illustrates a mobile device in which the touch sensor unit of FIG. 2A is employed;

FIG. 5 is a flow chart illustrating a method of controlling the sensitivity of the touch sensor according to an embodiment of the present invention;

FIG. 6 illustrates a user interface (UI) model which can be applied to the touch sensor unit illustrated in FIG. 2A;

FIG. 7A illustrates an example of a standard input pattern outputted using the method of controlling the sensitivity of the touch sensor illustrated in FIG. 5;

FIG. 7B illustrates another example of a standard input pattern outputted using the method of controlling the sensitivity of the touch sensor illustrated in FIG. 5;

FIG. 8 illustrates an active region and an inactive region which are divided from each other and used in the method of controlling the sensitivity of the touch sensor illustrated in FIG. 5;

FIG. 9 is a plan view illustrating weight values that are applied according to the active region and the inactive region illustrated in FIG. 8;

FIG. 10 is a three-dimensional view illustrating weight values that are applied according to the active region and the inactive region illustrated in FIG. 8;

FIG. 11 illustrates a pattern inputted by a user using the touch sensor unit illustrated in FIG. 2A; and

FIG. 12 is a flow chart illustrating a method of reducing an error generation rate by comparing the pattern illustrated in FIG. 11 with a standard input pattern.

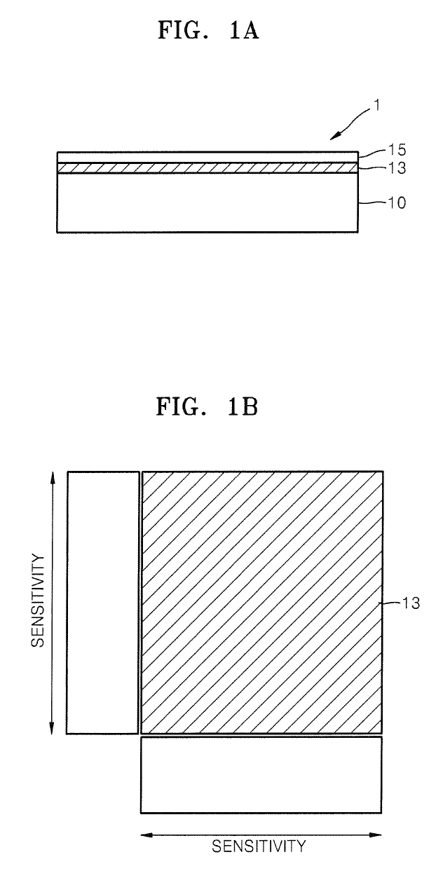

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

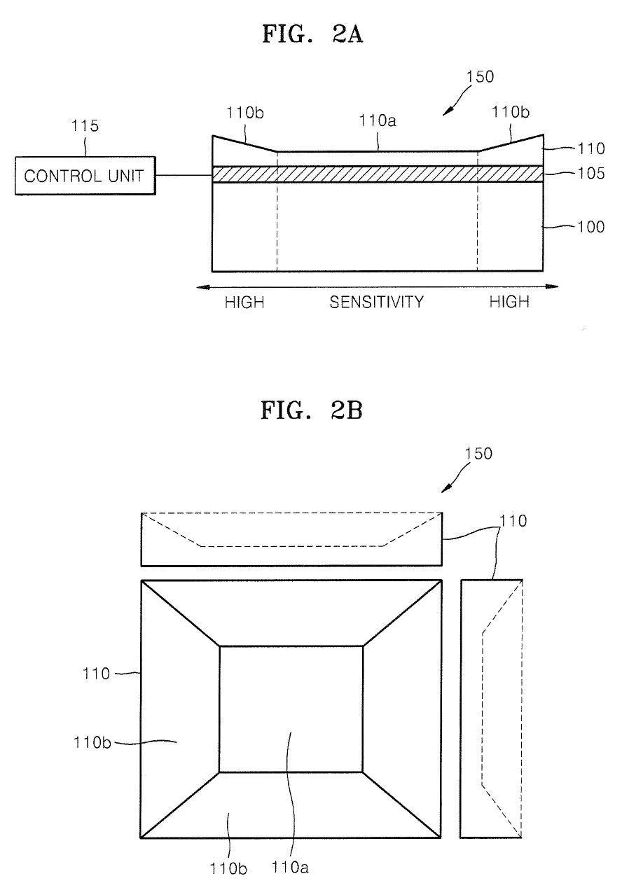

FIG. 2A is a diagram of a touch sensor unit 150 having a layered structure according to an embodiment of the present invention, and FIG. 2B shows a plan view and a side view of the touch sensor unit 150 illustrated in FIG. 2A. Referring to FIGS. 2A and 2B, the touch sensor unit includes a supporting substrate 100, a touch sensor 105 disposed on the supporting substrate 100, and a cover 110 having a non-uniform thickness disposed on the touch sensor 105. It is understood that the term “thickness” refers to a distance between a side of the cover 110 contacting the touch sensor 105 and an opposite side of the cover 110 which a user enters input orders into.

In addition, the touch sensor unit 150 further includes a control unit 115 which controls the cover 110 to have a uniform sensitivity according to a shape of the cover 110, even if the cover 110 is designed by a user to have a non-uniform thickness. The control unit 115 collects three-dimensional location data of the cover 110 and measures the sensitivity of the touch sensor 105 corresponding to the three-dimensional location data. Then, the sensitivity is controlled by applying weighted values to the measured sensitivity.

The three-dimensional location data can be generated by using a three-dimensional modeling function and the weighted values can be obtained by applying an inverse transformation to the three-dimensional modeling function. For example, the control unit 115 applies the weighted values, which are proportional to the thicknesses of corresponding portions of the cover 110, to the measured sensitivity to control the sensitivity. As such, since the control unit 115 controls the sensitivity of the touch sensor 105 to be uniform, regardless of whether the cover 110 has a uniform thickness, an error generation rate of the touch sensor 105 is reduced and the touch sensor unit can be designed in various ways. While FIGS. 2A and 2B depict a cover having a non-uniform thickness, it is understood that the cover 110 is not required to have a non-uniform thickness to function with aspects of the present invention.

The cover 110 can be designed in various ways. According to an embodiment, the cover 110 includes a center portion 110a and an inclined portion 110b inclining upward from the center portion 110a as illustrated in FIG. 2A. A thickness of the center portion 110a is relatively small and a thickness of the inclined portion 110b is relatively large. In addition, the thickness of the inclined portion 110b gradually increases from the center portion 110a to the outer edges of the touch sensor unit 150. As described above, the thickness of the cover 110 is not uniform and a contact force sensed by the touch sensor 105 varies according to the thickness of the cover 110. In other words, a region where the thickness of the cover 110 is relatively large has lower sensitivity than a region where the thickness of the cover 110 is relatively small and thus the contact force sensed by the touch sensor 105 differs depending on which region is contacted. In this case, the control unit 115 calculates weighted values of the sensitivity proportional to the thickness of the cover 110, with respect to data inputted from the touch sensor 105 to control the sensitivity of the touch sensor 105, and thus the cover 110 is controlled to have uniform sensitivity over the entire surface which a user touches to input commands.

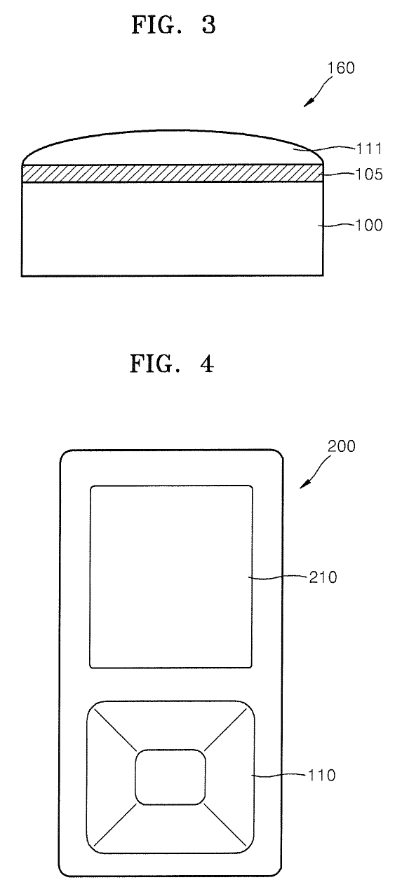

FIG. 3 is a diagram of a touch sensor unit 160 according to another embodiment of the present invention. In FIG. 3, a cover 111 has a dome shape with an elevated center portion. The thickness of the cover 111 is relatively large at the elevated center portion and gradually decreases in the declined portion towards the sides of the touch sensor unit 160. In this case, a relatively high weight is applied to the sensitivity of the center of the cover 111 to uniformly control the overall sensitivity. Additionally, the cover according to aspects of the present invention may have a wide variety of shapes other than the two covers 110 and 111 respectively depicted in FIGS. 2A and 3. For example, the cover may have concentric circles or other patterns which have raised portions and flat portions, or may be thicker or thinner according to the location of buttons. Moreover, different covers may be substituted onto the touch sensor unit 150, for example, in different colors or styles, according to a user preference or other considerations.

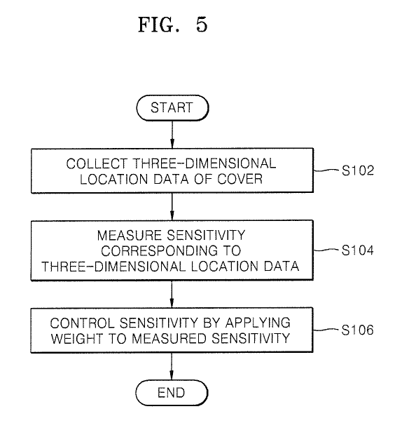

FIG. 4 illustrates a mobile device 200 in which the touch sensor unit 150 of FIG. 2A is employed. The touch sensor unit 150 according to aspects of the present invention can be employed in an input device of a mobile device 200 such as a cellular phone, an mp3 player, a Portable Multimedia Player (PMP), a video game controller, a television controller, a camera, and devices to transmit and/or receive Digital Multimedia Broadcasting (DMB). When a user contacts a cover 110 of the touch sensor 105, an input order according to a touch of the user is input and displayed in a display unit 210. It is understood that the mobile device 200 can also have audio units (not shown) to input and output audio, such as headphone jacks, speakers, etc., and data units (not shown) to input and output data, such as a USB terminal, an infra-red receiver/transmitter, etc. It is further understood that the touch sensor unit 150 according to aspects of the present invention can also be employed in stationary technology, such as a user interface on a printer, a set top box, a scanner, a multifunction device, a desktop computer, or any other kind of control panel.

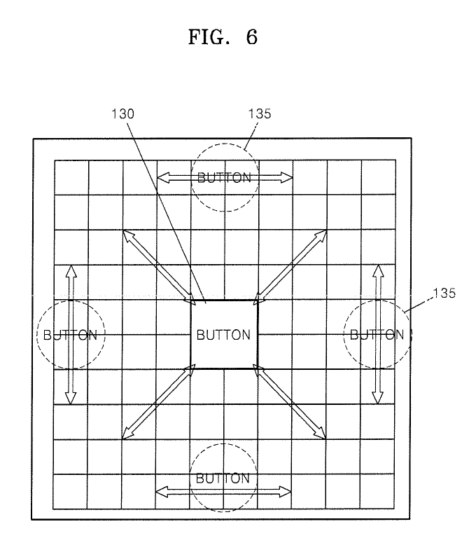

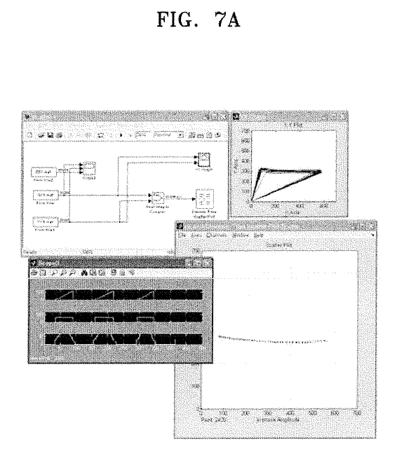

A method of controlling the sensitivity of the touch sensor 105 according to an embodiment of the present invention will be described with reference to FIG. 5. Hereinafter, the touch sensor unit 150 (FIG. 2A) will be used an example embodiment, however, it is understood that other embodiments of the touch sensor unit, such as the touch sensor unit 160 illustrated in FIG. 3, may also be used in accordance with the methods described below. FIG. 5 is a flow chart illustrating a method of controlling the sensitivity of the touch sensor 105. In order for the touch sensor unit 150 to be used in an input device, a User Interface (UI) model with respect to the input device is composed. FIG. 6 illustrates an example of a UI model which can be applied to the touch sensor unit 150 of FIG. 2A. According to the UI model, an input button is located in a center portion 130 of a square shaped cover, and four more input buttons are located midway between each side of the square shaped cover, at the locations indicated by the reference numeral 135.

The cover 110 is formed according to the UI model and is installed on the touch sensor 105. Then, in operation S102, three-dimensional location data of the cover 110 is collected. The three-dimensional location data is information which describes the three-dimensional shape of the cover 110, including the length, width, and thickness dimensions. Next, in operation S1 04, sensitivity corresponding to the three-dimensional location data is measured. Next, in operation S1 06, weighted values are applied to the measured sensitivity in order to control the measured sensitivity to make the measured sensitivity uniform.

The three-dimensional location data can be formed using a three-dimensional modeling function. When an inverse transform function is obtained by applying an inverse transform to the three-dimensional modeling function, the sensitivity value reflecting the weighted values of the sensitivity corresponding to the regions of the three-dimensional shape of the cover 110 can be obtained. When the sensitivity value inputted through the touch sensor is substituted for the inverse transform function, the corresponding weighted values are applied to obtain the corrected sensitivity values.

After the sensitivity is controlled in operation S106 as described above, a correction range of the touch sensor 105 is set. When the unprocessed location data is inputted as the user contacts the cover 111, the sensitivity corresponding to the location data is corrected to be in the correction range of the touch sensor 105.

Next, tuning work is performed on the sensitivity of the touch sensor 105 to reduce errors due to effects of the surrounding environment. In order to perform the tuning work, the cover 111 is placed on the touch sensor 105, and then a sensitivity value corresponding to two dimensional location data, which has been outputted by the touch sensor 105 through a measuring jig, is measured. The sensitivity value can be measured by, for example, a capacitive value. When the measured sensitivity value of a specific region of the cover 111 is determined to be outside the correction range, the measured sensitivity value is combined with the two dimensional location data to be repeatedly corrected and thus is included in the correction range. Therefore, errors due to effects of the surrounding environment are reduced.

Meanwhile, in order to reduce errors which may occur after the sensitivity is controlled to be uniform in operation S106, the following methods can be used. A usability test is performed with the touch sensor unit 150 by repeatedly touching the touch sensor unit 150 to collect the two-dimensional location data (x,y) for a contact point when the user contacts the cover 110. Then, a standard input pattern representing the highest frequency of use is generated using the two-dimensional location data. The two-dimensional location data includes an electrical characteristic value and is generally a value outputted through an Application Program Interface (API) provided by touch sensor manufacturers. The two-dimensional location data outputs a two-dimensional plane coordinate, an electrostatic capacity, or a pressure value when a user touches the touch sensor 105 after the touch sensor 105 is divided into two-dimensional plane coordinates (x,y).

The touch sensor 105 can be various different types of touch sensors, for example, a capacitive touch sensor 105, and a value outputted from the touch sensor 105 may be a two-dimensional coordinate value of the touch sensor 105 and an electrostatic capacity value obtained when a finger touches the touch sensor 105. As such, the standard input pattern can be determined based on statistics data obtained via the usability test according to a UI interaction method of the touch sensor 105.

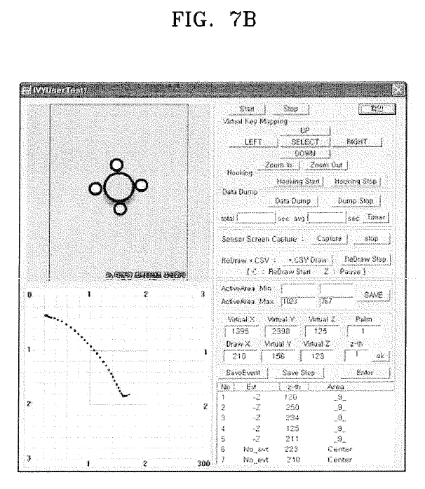

When the standard input pattern is generated from the two-dimensional location data, the Neural Network toolbox manufactured by MATLAB, for example, can be used to output a result about the sensitivity of the touch sensor 105. It is understood that other types of toolboxes can also be used to output a result. FIG. 7A illustrates an example of a standard input pattern outputted using a Neural Network toolbox manufactured by MATLAB. FIG. 7B illustrates another example of a standard input pattern and the data measured about the sensitivity of the touch sensor 105 using the Neural Network toolbox.

According to such a process, the sensitivity of the touch sensor unit 150 can be made uniform and a user can input an order to the touch sensor 105 which effectively has uniform sensitivity, regardless of the shape of the cover 110. When a user contacts the touch sensor unit 150, location data according to a contact of the user is converted into the standard input pattern to be recognized, and an input order by the user is performed according to the standard input pattern.

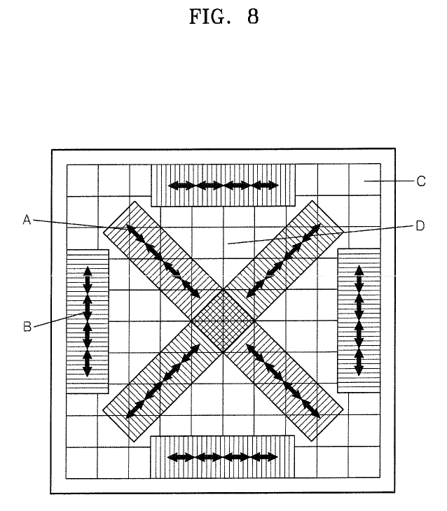

Meanwhile, when the standard input pattern is generated to further reduce an error generation rate due to UI interaction, the entire region of the touch sensor 105 can be divided into an active region and an inactive region to be managed separately. In other words, regions where the standard input pattern is generated are collectively managed as the active region, and regions where the standard input pattern is not generated are collectively managed as the inactive region. For example, in FIG. 8, a diagonal region A and an edge region B is the active region because these regions include standard input patterns represented by the boxes with black arrows, while a corner region C and a region D between the diagonal regions A is the inactive region. FIG. 8 illustrates the active region and the inactive region divided in the touch sensor unit 150 of FIG. 2A. As such, when the active region and the inactive region are set, in order to prevent against accidentally sensing the touch of a user in the inactive region, the weight in the inactive region is set to 0 so as to block a touch sensing output signal, thus minimizing an error generation rate.

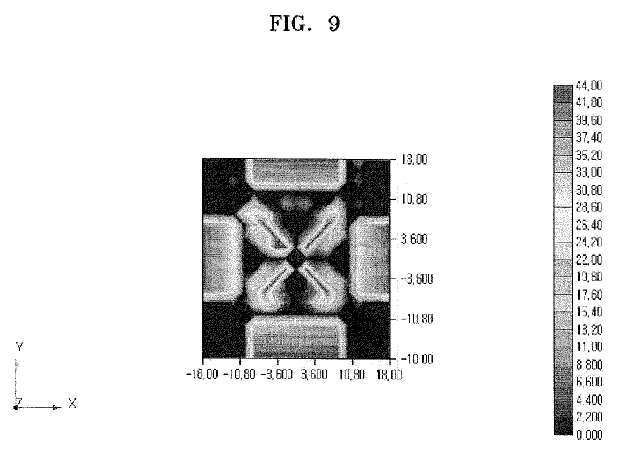

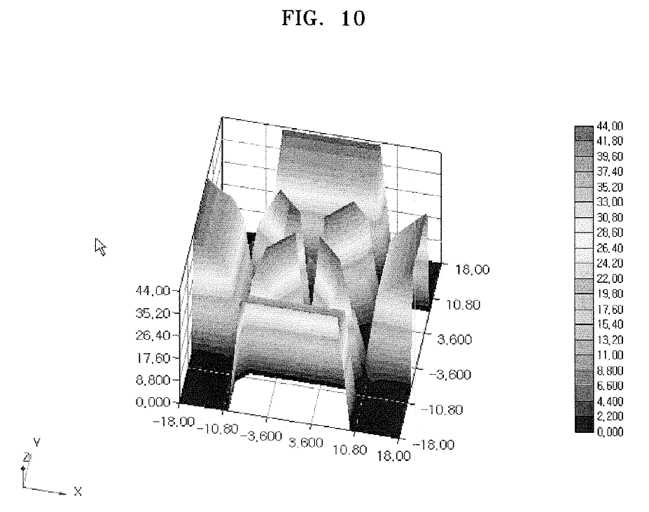

FIGS. 9 and 10 illustrate simulation results of the active region and the inactive region. FIG. 9 is a plan view illustrating weight values that are applied according to the active region and the inactive region illustrated in FIG. 8, and FIG. 10 is a three-dimensional view illustrating weight values that are applied according to the active region and the inactive region illustrated in FIG. 8. The inactive region shown in FIG. 8 is almost completely dark in FIG. 9, indicating that the inactive region has virtually no sensitivity when contacted by a user. Similarly, the inactive region shown in FIG. 8 is represented by the flat regions closest to the (x,y) plane in FIG. 10, further indicating that the inactive region has virtually no sensitivity when contacted by a user.

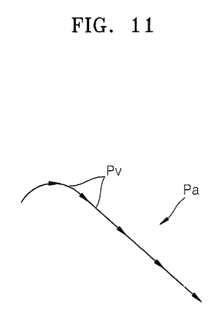

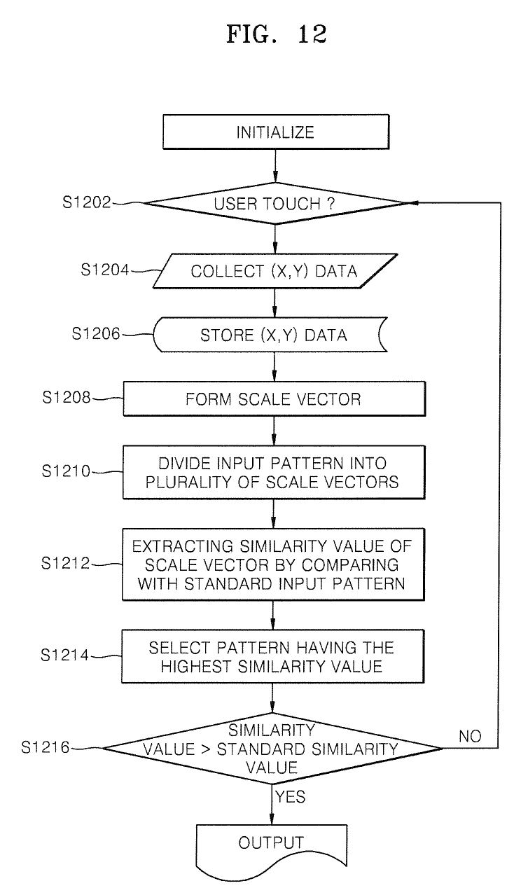

Next, FIG. 11 illustrates an input pattern Pa inputted by a user touching the touch sensor unit 150, and FIG. 12 illustrates a method of reducing an error generation rate according to an aspect of the present invention. In operation S1202, it is determined whether the user has touched the touch sensor unit 150. When the user touches the touch sensor unit 150, location data (x,y) is collected in operation S1204 and stored in a memory (not shown) in operation S1206. Then, in operation S1208 the stored location data (x,y) is used to generate a scale vector. The scale vector has a cosine value and size according to a unit time obtained from the location data (x,y).

In operation S1210, the input pattern Pa is divided into a plurality of the scale vectors Pv and then a cosine value and size of each of the scale vectors Pv is compared with the standard input pattern P (not shown). In operation S1212, a similarity value is extracted from a comparison between the scale vectors Pv and the standard input pattern P (not shown), and the similarity value higher than a predetermined standard input pattern is taken. Then, in operation S1214, the scale vector Pv having the highest similarity value to the standard input pattern P (not shown) is selected. In addition, the selected scale vector Pv having the highest similarity value to the standard input pattern P (not shown) is recognized as the desired input command of a user. At operation S1216, the selected scale vector Pv is compared to a standard similarity value. When the scale vector Pv is smaller than the standard similarity value, the scale vector is not recognized as an input order. Therefore, the input pattern Pa is compared against the standard input pattern P (not shown) inputted into the touch sensor 105, thus reducing an error generation rate for the user.

As described above, the touch sensor 105 according to aspects of the present invention maintains a uniform sensitivity regardless of the shape and thickness of the cover 110, thus allowing the cover 110 to be designed in various shapes and thicknesses. In addition, the method of controlling the sensitivity of the touch sensor according to aspects of the present invention controls the touch sensor unit to have uniform sensitivity regardless of the shape and thickness of the cover 110 included in the touch sensor unit 150, thus reducing an input error rate.

While not required in all aspects, aspects of the invention can be implemented using a computer program encoded on a medium readable by a computer. For example, the control unit 115 (FIG. 2A) may be embodied as a computer program. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, codes, and code segments for accomplishing aspects of the present invention can be easily construed by programmers skilled in the art to which aspects of the present invention pertain.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A touch sensor unit comprising:
a supporting substrate;
a touch sensor disposed on the supporting substrate;
a cover having a three-dimensional form disposed on the touch sensor; and
a control unit to control a sensitivity of the touch sensor by applying weighted values to the sensitivity, wherein the sensitivity corresponds to three-dimensional location data of the cover.

2. The touch sensor unit of claim 1, wherein the weighted values are proportional to a thickness of the cover.

3. The touch sensor unit of claim 1, wherein the cover comprises:
an active region in which a touch signal is recognized; and
an inactive region in which the touch signal is blocked.

4. The touch sensor unit of claim 3, wherein the cover comprises:
a square-shaped center portion; and
an inclined portion increasing in thickness from a periphery of the center portion to respective sides of the cover.

5. The touch sensor unit of claim 4, wherein the active region comprises:
the center portion;
diagonal regions of the center portion which each extend from one corner of the center portion to an opposite corner of the center portion; and
an outer edge region of the inclined portion.

6. The touch sensor unit of claim 1, wherein the touch sensor is employed in a mobile device.

7. A method of controlling a sensitivity of a touch sensor unit having a supporting substrate, a touch sensor disposed on the supporting substrate, and a cover disposed on the touch sensor, the method comprising:
collecting three-dimensional location data of the cover;
measuring a sensitivity of the touch sensor corresponding to the three-dimensional location data; and
controlling the sensitivity by applying weighted values to the measured sensitivity.

8. The method of claim 7, wherein the three-dimensional location data is generated using a three-dimensional modeling function.

9. The method of claim 8, wherein the weighted values are obtained by applying an inverse transform to the three-dimensional modeling function.

10. The method of claim 7, further comprising:
setting a correction range of the touch sensor; and
controlling the sensitivity of the touch sensor to be corrected within the correction range.

11. The method of claim 7, wherein the cover comprises:
an active region in which a touch signal is recognized; and
an inactive region in which the touch signal is blocked.

12. The method of claim 7, further comprising obtaining a standard input pattern by performing a usability test.

13. The method of claim 12, wherein the performing of the usability test comprises:
repeatedly touching the touch sensor unit to collect two-dimensional location data for a contact point; and
generating a standard input pattern representing a highest frequency of use according to the two-dimensional location data.

14. The method of claim 13, further comprising:
dividing an input pattern based on a touch signal inputted by a user into a plurality of scale vectors;
measuring a similarity value of each of the plurality of scale vectors by comparing the standard input pattern to each of the plurality of the scale vectors from the input pattern; and
selecting an input order of the scale vectors according to the similarity values ranging from a highest similarity value to a lowest similarity value.

15. The method of claim 14, further comprising applying the weighted values to the measured sensitivity so that the weighted values are proportional to a thickness of the cover.

16. A touch sensor unit comprising:
a supporting substrate;
a touch sensor disposed on the supporting substrate;
a cover having a non-uniform thickness which a user presses to input commands; and
a control unit to adjust a sensitivity of the touch sensor to reduce input errors caused by the non-uniform thickness of the cover.

17. A method of controlling a sensitivity of a touch sensor unit having a supporting substrate, a touch sensor disposed on the supporting substrate, and a cover disposed on the touch sensor, the method comprising:
determining a thickness of the cover;
determining a sensitivity of the touch sensor corresponding to the thickness; and
adjusting the sensitivity to reduce input errors caused by deviations in the thickness.

18. A mobile device, comprising:
a display unit to display information; and
a touch sensor unit, comprising:
a supporting substrate,
a touch sensor disposed on the supporting substrate,
a cover having a three-dimensional form disposed on the touch sensor, and
a control unit to control a sensitivity of the touch sensor by applying weighted values to the sensitivity, wherein the sensitivity corresponds to three-dimensional location data of the cover.
